(19) United States
(12) Patent Application Publication
(10) Pub. No.: US 2013/0263465 A1
(43) Pub. Date: Oct. 10, 2013

(54) DRYER-HANGER SINGLE-BODY MACHINE

(71) Applicant: Jiebo Hu, Cixi City (CN)

(72) Inventor: Jiebo Hu, Cixi City (CN)

(21) Appl. No.: 13/824,162

(22) PCT Filed: Dec. 1, 2011
(86) PCT No.: PCT/CN2011/002013

§ 371 Date: Jun. 14, 2013

(30) Foreign Application Priority Data
Mar. 28, 2011 (CN) 201110082757.6
May 21, 2011 (CN) 201110147466.0

(51) Int. Cl. F26B 25/06

(52) U.S. Cl. CPC F26B 25/06
USPC 34/202

(57) ABSTRACT

A dryer-hanger single-body machine, comprises: a supporting body (1) at a base of the dryer-hanger single-body machine; a pillar (4) vertically provided above the supporting body (1); a drying unit (2) located at one side of the pillar (4); and a spare unit (3) located at the other side of the pillar (4). The drying unit (2) comprises: a drying rack member (21) located at one side of an upper end of the pillar (4); a hood (22) supported on the drying rack member (21) and naturally hanging down along one side of the pillar (4); and a heating member (23) for supplying a heated air into an inside space of the hood (22). The hood (22) is provided with an air outlet (226) and an air inlet (225). A vent port (232) of the heating member (23) is offset from the pillar (4) and hermetically connected to the air inlet (225) of the hood (22). The spare unit (3) comprises a spare hanging member (31) having a clothes-hanger (311). The dryer-hanger single-body machine not only has a simple structure, allowing convenient placement-retrieval of dried clothes, but also has a stable center of gravity, facilitating storage and reposition for families, thus allowing rapid and effective to dry and hang clothes.

### CROSS-REFERENCE TO RELATED APPLICATION

This application claims the benefit of Chinese Patent Application No. 201110082757.6 on Mar. 28, 2011 and Chinese Patent Application No. 201110147466.0 on May 21, 2011 filed in the State Intellectual Property Office of China, the whole disclosure of which is incorporated herein by reference.

### BACKGROUND OF THE INVENTION

1. Field of the Invention

The present invention relates to an apparatus for processing clothes, more particularly, relates to a dryer-hanger single-body machine.

2. Description of the Related Art

In recent years, various family electric appliance for processing clothes, such as a canopy-type dryer, a bracket-type iron and a portable iron, are available in the domestic electric appliance market. Generally, the canopy-type dryer and the bracket-type iron are not adapted to be used in a small room of a family because they need occupying a large space. On the other hand, the portable iron can be folded and needs occupying less space than the bracket-type iron, as a result, the portable iron is commonly used in the family to iron clothes. However, if the portable iron is used, a hanger for hanging ironed clothes must be prepared to achieve a complete operation of processing clothes together with the portable iron, therefore, it is not convenient in use.

For example, a Chinese patent publication No.CN2567261Y discloses a dryer in which a canopy-type dryer is described.

Accordingly, the above conventional clothes processing apparatus have the following disadvantages:

(1). Since a supporting pillar is disposed inside a flexible hood, the supporting pillar occupies an interior space of the flexible hood and hinders the placement-retrieval of dried clothes, more particularly, it is more inconvenient when the clothes processing apparatus has a compact structure for tourist's use. Furthermore, the conventional dryer lacks the function of hanging clothes during ironing clothes by the portable iron.

(2). In the conventional clothes processing apparatus, the control switch is provided on the housing of the clothes processing apparatus, a cylinder-type hood is sleeved on a spread rack for spreading the hood and has a lower port terminated at a joint of a vent canopy and the housing. The size of a bottom end surface of the cylinder-type hood is far larger than that of a profile of the housing, therefore, the hood just covers the whole housing when the hood is spread and charged by air. In order to know the drying state of clothes in use at any moment, the user needs often watching the timing scale value of the control switch. However, with the conventional structure, the user cannot see the control switch on the housing within a distance of 1.5 m from the hood if he/she stands, therefore, the user must squat down to watch and operate the control switch. Generally, the user cannot clearly see the timing scale value and running state of the control switch beyond a distance of 1.5 m from the hood due to the limitation of the human eyesight. Accordingly, in the practical use, the user only can faintly see the approximate position of the control switch and needs come near for adjusting the control switch. Obviously, it is very inconvenient for the user. Thereby, the user reflects such problem to the manufacturer. For solving this problem, the technician proposes a solution to enlarge the housing so that the control switch may be located at an outer location much closer to the user than before, for facilitating the user's watching and operating near the control switch. However, this solution causes a large bulk of housing. As a result, it is difficult to store the large bulk of housing, and it increases the manufacture cost and the production price. Furthermore, so far, there is not a well solution to be taken by both the user and the manufacturer.

(3). The conventional dryer comprises a supporting leg, a housing, a vent canopy, a supporting pillar and a spread bracket that are arranged and connected in an order from the bottom to the top of the dryer. Therefore, the integral strength of the dryer is dependent on the above fiver parts themselves' structure and the connection structure thereof. Apparently, the integral strength and stability of the dryer will be decreased when too many connection members are used to the above five parts. In addition, the vent canopy not only serves to vent air, but also carries and transfers the weight of the dryer. Accordingly, the vent canopy is the main part for improving the integral strength of the dryer. But, it is appreciated for those skilled in this art that the improvement to the vent canopy is limited by various difficulties in design and manufacture technology as well as the cost of the material. Furthermore, since the vent canopy may be deformed and the dryer may be broken down when clothes are not hanged evenly on the spread bracket or too many clothes are hanged on the spread bracket, the total weight and volume of clothes hanged on the spread bracket is limited.

Furthermore, in the prior art, the supporting pillar is disposed within the hood, and the heat from the hot air in the hood may be directly transferred to the supporting pillar to cause the supporting pillar overheated, it is not safe in the use of the dryer.

### SUMMARY OF THE INVENTION

The present invention has been made to overcome or alleviate at least one aspect of the above mentioned disadvantages.

Accordingly, it is an object of the present invention to provide a dryer-hanger single-body machine that has a high safety in use and a stable center of gravity and is convenient for placement-retrieval of dried clothes and operation of a control switch.

According to an aspect of the present invention, there is provided a dryer-hanger single-body machine, comprising: a supporting body at a base of the dryer-hanger single-body machine; a pillar vertically provided above the supporting body; a drying unit located at one side of the pillar; and a spare unit located at the other side of the pillar. The drying unit comprises: a drying rack member located at one side of an upper end of the pillar; a hood supported on the drying rack member and naturally hanging down along one side of the pillar; and a heating member for supplying a heated air into an inside space of the hood. The hood is provided with an air outlet and an air inlet. A vent port of the heating member is offset from the pillar and hermetically connected to the air inlet of the hood, and the spare unit comprises a spare hanging member having a clothes-hanger.

In order to reduce the bulk of the dryer-hanger single-body machine, the heating member is disposed within the supporting body. An intake port and the vent port are provided in a case of the supporting body. An air passage is formed within the supporting body and located between the intake port and the vent port. The heating member comprises a blower and a heating element located within the air passage.

In order to decrease the temperature of the hot air generated by the heating member before entering into the hood, a chamber is provided between the vent port of the heating member and the air inlet formed in a bottom of the hood. A top plate of the chamber is matched with the air inlet of the hood and has a plurality of vent holes communicated with the hood.

Preferably, for decreasing the temperature of the hot air generated by the heating member, a chamber is provided between the hood and the supporting body and connected to the air inlet of the hood. The chamber is communicated with an intake hole. A separate plate is disposed within the chamber to separate the chamber into an upper slow air chamber and a lower electronic chamber communicated with the upper slow air chamber. The heating member is fixed on the separate plate.

Preferably, the intake hole is formed in a side wall of the chamber; or the chamber is communicated with the supporting body, and the intake hole is formed in supporting body. In another preferable embodiment of the present invention, the heating member is fixed on a portion of the pillar above the drying rack member, a middle portion of the pillar between the drying rack member and the supporting body, or a lower end of the pillar.

Preferably, for decreasing the temperature of the hot air generated by the heating member, in a case where the heating member is fixed on the portion of the pillar above the drying rack member, a separate plate is disposed within a case of the heating member to separate the case of the heating member into an upper electronic chamber and a lower slow air chamber communicated with the upper electronic chamber. A blower and a heating element of the heating member are coaxially fixed on the separate plate within the electronic chamber. An intake port is formed in an upper end of the case of the heating member, and a plurality of vent holes are distributed in a bottom plate of the case of the heating member and communicated with an upper port of the hood that is acted as the air inlet.

Preferably, in a case where the heating member is fixed on the lower end of the pillar, a plurality of vent holes are formed in a top plate of a case of the heating member and communicated with a lower port of the hood that is the air inlet. A plurality of intake ports are formed in a bottom of the case of the heating member. A separate plate is disposed within the case of the heating member to separate the case into a lower electronic chamber and an upper slow air chamber communicated with the lower electronic chamber. A blower and a heating element of the heating member are coaxially fixed on the separate plate within the electronic chamber.

In order to fully spread and fix the top of the hood, the drying rack member comprises a supporting top frame and a side fastener located on the supporting top frame. A top end of the hood is fixed on the supporting top frame and secured on the upper end of the pillar by the side fastener.

Preferably, for achieving a compact hood in bulk, the supporting top frame has an elliptic shape with a receiving width equal to a width between two shoulders of a jacket, as well as a receiving thickness equal to a thickness between chest and back of the jacket. The side fastener is located at a middle location of the supporting top frame in a direction of the receiving width.

In order to more stably fix a seal connection between the supporting top frame and the heating member, in a case where the heating member is fixed on the portion of the pillar above the drying rack member, the supporting top frame is fixed in a ring recess formed at an outside of the bottom of the case of the heating member.

For fully spreading the bottom of the hood, the bottom of the hood includes a bottom frame or a bottom plate that is secured on the lower end of the pillar by a side fastener.

In order to more stably fix the bottom frame, in a case where the heating member is fixed on the lower end of the pillar, the bottom frame is received in a ring recess formed at an outside of the top of the case of the heating member.

Preferably, the spare hanging member further comprises a clothes-hook located below the clothes-hanger and fixed on the pillar.

In order to prevent the hood from swaying relative to the pillar, a lower aperture and an upper aperture are formed in a back side of the hood. A section of the pillar enters into an inside of the hood through the lower aperture and the upper aperture.

For fixing the position of the hood relative to the pillar, the back side of the hood has a fixing means to be fixed on the pillar.

Preferably, the fixing means is configured to be a fastener structure striding over the pillar and fixed on the back side of the hood, a sleeve structure for the pillar passing therethrough, or a combination structure thereof.

In order to simply hang the clothes in the drying unit and the spare unit, the drying unit includes a clothes-hanging means that is configured to be a first extension arm, on which a plurality of clothes-hooks are provided, extending from the top end of the pillar toward a side of the drying rack member. The spare unit includes a further clothes-hanging means that is configured to be a second extension arm, on which a plurality of clothes-hooks are provided, extending from the top end of the pillar toward a top of the spare unit.

In order to allow an iron device to easily pass through the pillar to reach the back of clothes as the spare unit is used to iron clothes, the pillar comprises a first supporting rod and a second supporting rod that are separated from each other by a predetermined horizontal distance and parallel to each other to form a “∥”-shaped structure. The drying rack member is located on the second supporting rod, and the spare unit is located on the first supporting rod.

In order to allow an iron part to easily pass through the pillar to reach the back of clothes as the spare unit is used to iron clothes, the pillar comprises a first supporting rod and a second supporting rod of which upper ends are separated from each other by a predetermined horizontal distance and of which lower ends are connected to each other to form a “Y”-shaped structure. The drying rack member is located on the second supporting rod, and the spare unit is located on the first supporting rod.

For improving the structure stability of the pillar, the pillar comprises a first supporting rod and a second supporting rod of which lower ends are separated from each other by a predetermined horizontal distance and of which upper ends are connected to each other to form a “n”-shaped structure. The drying rack member is located on the second supporting rod, and the spare unit is located on the first supporting rod.

As a variation embodiment of the present invention, the drying rack member comprises a spread means having a clothes-hanging structure and a pan-like structure for spreading the hood. The clothes-hanging structure is hanged on a first extension arm laterally extending from the top end of the pillar.

In order to easily fold and store the dryer-hanger single-body machine, the pillar is configured to be a telescopic structure comprising a plurality of segments. A locking means is provided at a joint of two adjacent segments.

In order to easily fold the hood to a folded state with a small volume, the dryer-hanger single-body machine further comprises a tying means for tying the hood on the pillar.

Compared with the prior arts, the present invention has the following advantages:

(1) The drying unit is located at one side of the pillar, and the vent port of the heating member is also located at the one side of the pillar. Furthermore, the vent port is hermetically connected to the air inlet of the hood and is offset from the pillar to separate from the pillar. Accordingly, the dryer-hanger single-body machine has a stable center of gravity, and the hot air flow from the heating member cannot be directly transferred to the pillar during drying clothes so that the pillar is prevented from being overheated, improving the safety in drying clothes. Furthermore, the spare unit is located at the other side of the pillar, therefore, spare clothes may be hanged on the spare unit and the user need not preparing an additional hanger in advance for hanging the spare clothes during drying clothes. Since the drying and hanging of clothes are independent from each other, it can markedly shorten the time for processing clothes, and the operation is very simple and rapid with small power consumption. The hanging of the spare clothes and the drying of the wet clothes can be performed at a same time to complete the processing of the clothes in a predetermined time, improving the use efficiency of the machine and the work efficiency of the user.

(2) Since the pillar does not occupy the inner space of hood, it is very convenient for the user to place and retrieve (or access) clothes and allows the hot air to flow smoothly in the hood, increasing the drying efficiency.

(3) The hood is disposed at one side of the pillar so that a region at the other side of the pillar is not hidden by the hood, and the control switch is provided on a respective supporting body in the region that is not hidden by the hood, therefore, the user can easily watch and operate the control switch. However, in the conventional dryer, the hood covers the whole pillar and the vent canopy, and the lower circumferential portion of the hood covers the upper portion of the whole supporting body and hides the control switch, as a result, the user must squat near the control switch to watch and operate it.

(4) The vent canopy of the conventional dryer is omitted, and the pillar is directly fixed on the supporting body, increasing the mechanical strength and the safety and improving the carrying stability of the dryer-hanger single-body machine.

(5) Since the pillar does not occupy the inner space of hood, the hood can be designed to have a receiving width equal to a width between two shoulders of a jacket as well as a receiving thickness equal to a thickness between chest and back of the jacket, therefore, the present invention provides a receiving space for drying the jacket. Furthermore, the pillar is located at a middle location of the supporting top frame in a direction of the receiving width. Accordingly, the dryer-hanger single-body machine has a compact structure and a stable center of gravity, and can provide an enough receiving space to receive one or more pieces of clothes, improving the drying efficiency and saving the power consumption.

### BRIEF DESCRIPTION OF THE DRAWINGS

These and/or other aspects and advantages of the invention will become apparent and more readily appreciated from the following description of the embodiments, taken in conjunction with the accompanying drawings, in which:

FIG. 1 is a side view of a dryer-hanger single-body machine according to a first embodiment of the present invention;

FIG. 2 is a top view of the dryer-hanger single-body machine according to the first embodiment of the present invention;

FIG. 3 is a schematic perspective view of the dryer-hanger single-body machine according to the first embodiment of the present invention;

FIG. 4 is a schematic work state view of the dryer-hanger single-body machine according to the first embodiment of the present invention;

FIG. 5 is a local cross section view of a supporting body of the dryer-hanger single-body machine according to the first embodiment of the present invention;

FIG. 6 is a local cross section view of a chamber of the dryer-hanger single-body machine according to the first embodiment of the present invention;

FIG. 7 is a schematic perspective view of a dryer-hanger single-body machine according to a second embodiment of the present invention;

FIG. 8 is a schematic back view of a hood of the dryer-hanger single-body machine according to the second embodiment of the present invention;

FIG. 9 is a schematic perspective view of a dryer-hanger single-body machine according to a third embodiment of the present invention;

FIG. 10 is a cross section view of a heating member of the dryer-hanger single-body machine according to the third embodiment of the present invention;

FIG. 11 is a side view of the dryer-hanger single-body machine according to the third embodiment of the present invention;

FIG. 12 is a side view of a dryer-hanger single-body machine according to a fourth embodiment of the present invention;

FIG. 13 is a cross section view of a heating member of the dryer-hanger single-body machine according to the fourth embodiment of the present invention;

FIG. 14 is a perspective view of a dryer-hanger single-body machine according to a fifth embodiment of the present invention;

FIG. 15 is a top view of the dryer-hanger single-body machine according to the fifth embodiment of the present invention;

FIG. 16 is a schematic work state view of the dryer-hanger single-body machine according to the fifth embodiment of the present invention;

FIG. 17 is a back state view of a hood of the dryer-hanger single-body machine according to the fifth embodiment of the present invention;

FIG. 18 is a side view of a dryer-hanger single-body machine according to a sixth embodiment of the present invention;

FIG. 19 is a top view of the dryer-hanger single-body machine according to the sixth embodiment of the present invention;

FIG. 20 is a side view of a variation of the dryer-hanger single-body machine according to the sixth embodiment of the present invention;

FIG. 21 is a perspective view of a dryer-hanger single-body machine according to a seventh embodiment of the present invention;

FIG. 22 is a top view of the dryer-hanger single-body machine according to the seventh embodiment of the present invention;

FIG. 23 is a cross section view of a hood of a dryer-hanger single-body machine according to an eighth embodiment of the present invention;

FIG. 24 is a local enlarged view of a portion B indicated in FIG. 23;

FIG. 25 is a schematic perspective view of a dryer-hanger single-body machine according to a ninth embodiment of the present invention;

FIG. 26 is a schematic view of the dryer-hanger single-body machine in another state according to the ninth embodiment of the present invention;

FIG. 27 is a schematic perspective view of a dryer-hanger single-body machine according to a tenth embodiment of the present invention;

FIG. 28 is a local perspective view of the dryer-hanger single-body machine according to the tenth embodiment of the present invention;

FIG. 29a and FIG. 29b shows a view of a pillar of a dryer-hanger single-body machine according to an eleventh embodiment of the present invention, wherein FIG. 29a shows the pillar in a loosened state, and FIG. 29b shows the pillar in a locked state;

FIG. 30 is a back view of a hood of the dryer-hanger single-body machine according to the eleventh embodiment of the present invention;

FIG. 31a and FIG. 31f shows a view of a dryer-hanger single-body machine according to a twelfth embodiment of the present invention, wherein FIG. 31a is a schematic view showing a heating member located on the top of a pillar, FIG. 31b is a schematic view showing a heating member fixed above the pillar, FIG. 31c is a schematic view showing a heating member fixed on a supporting frame above the pillar, FIG. 31d is a schematic view showing a heating member located at the middle portion of the pillar, FIG. 31e is a schematic view showing a heating member located at the bottom of the pillar, FIG. 31f is a schematic view showing a heating member located on a bottom plate under the pillar;

FIG. 32 is a view of a dryer-hanger single-body machine according to a thirteenth embodiment of the present invention;

FIG. 33 is an operation track view of a dryer-hanger single-body machine according to the present invention; and

FIG. 34 is an operation region distribution view of a dryer-hanger single-body machine according to the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

First Embodiment

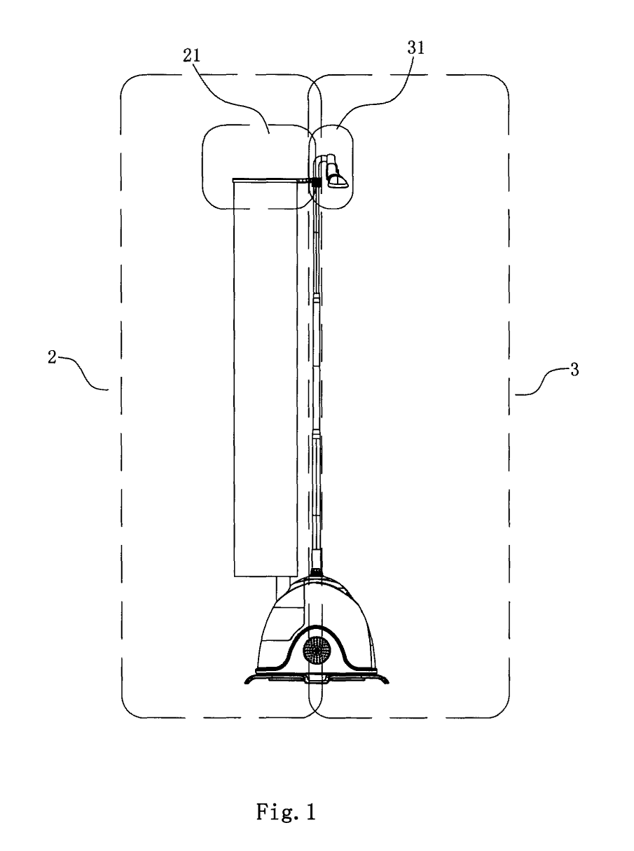

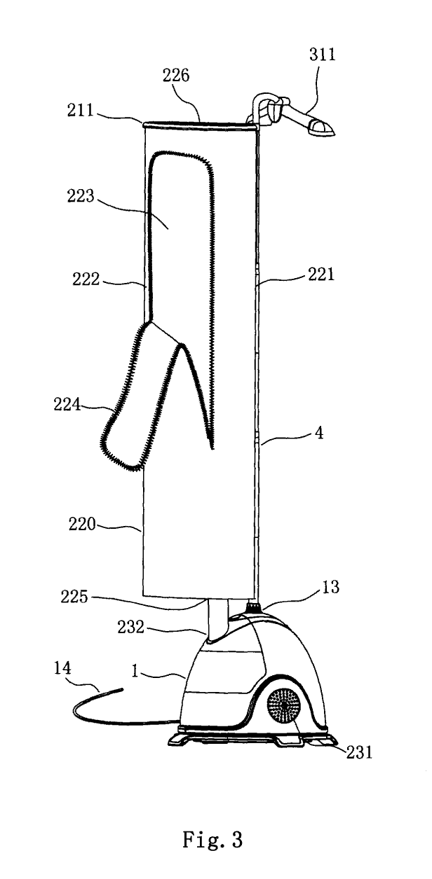

As shown in FIGS. 1-6, a dryer-hanger single-body machine according to preferable embodiments of the present invention is described.

The dryer-hanger single-body machine mainly comprises a supporting body 1, a pillar 4 having a lower end fixed on the supporting body 1, and a drying unit 2 and a spare unit 3 located at a left side and a right side of the pillar 4, respectively.

The spare unit 3 comprises a spare hanging member 31 disposed on the pillar 4 for hanging spare clothes, the spare hanging member 31 may comprise a clothes-hanger 311.

The drying unit 2 comprises a drying rack member 21 located at the left side of the pillar 4 and fixed on an upper end of the pillar 4, a hood 22 having an upper end suspended on the drying rack member 21 and naturally hanging down along the left side of the pillar 4, and a heating member 23 disposed within the supporting body 1.

A control panel 12 for controlling the single-body machine, power lines 14 for connecting the supporting body 1 to an external power supply, and an intake port 231 and a vent port 232 of the heating member 23 are provided on/in a case of the supporting body 1. An air passage 239 is formed within the supporting body 1 to connect the intake port 231 and the vent port 232. The heating member 23 comprises a blower 238 and a heating element 237 located within the air passage 239.

A fixing portion 13 for the pillar 4 is provided on the case of the supporting body 1 and is separated from the vent port 232 by a horizontal distance, that is, the vent port 232 is offset from the pillar 4. The pillar 4 has a lower end fixed on the fixing portion 13 and an upper end 41. The drying rack member 21 is fixed on the left side of the upper end 41 and the spare member 31 is fixed on the right side of the upper end 41.

The drying rack member 21 is located above the pillar 4 at a side corresponding to the vent port 232. The drying rack member 21 comprises a supporting top frame 211. An upper end of the hood 22 is sleeved and suspended on the supporting top frame 211. The hood 22 naturally hangs down along the supporting top frame 211 at the left side of the pillar 4 and is formed with a back side 221 proximate to the surface of the pillar 4 and a front side 222 opposite to the back side 221. A receiving space 223 for drying clothes is formed between the back side 221 and the front side 222 within the hood 22. A door 224 for the placement-retrieval or accessing of clothes is opened in the front side 22 of the hood. An air outlet 226 is provided in the upper portion of the hood 22, and an air inlet 225 is provided in the lower portion 220 of the hood 22 and hermetically connected to the vent port 232 of the heating member 23. The hot air generated by the heating member 23 flows into the receiving space 223 through the air passage 239 to dry clothes, and the vapor produced during the drying is exhausted outside through the air outlet 226 in the upper portion of the hood.

The spare clothes are hanged on the spare hanging member 31. Accordingly, a drying region A is formed in a left side region of the pillar 4 where the hood 22 is provided, and a spare region B is formed in a right side region of the pillar 4 opposite to the left side region. Therefore, the drying region A and the spare region B are separately disposed at opposite sides of the pillar 4. The clothes are dried with the drying unit 2 in the drying region A, and the spare clothes are hanged with the spare unit 3 in the spare region B. The drying unit 2 and the spare unit 3 are independent from each other and need occupying small space in the room. Because the hood 22 does not hinder the placement-retrieval or accessing of clothes on the spare unit 3 in the spare region B, an open and individual environment is provided for the placement-retrieval of clothes. When the clothes are dried in the drying region A, the clothes hanged on the drying rack member 21 is covered by the hood 22. In this way, hanging the clothes on the pillar does not affect the drying operation of clothes, and it provides an individual environment for drying clothes in a high efficiency without the hindrance of the pillar.

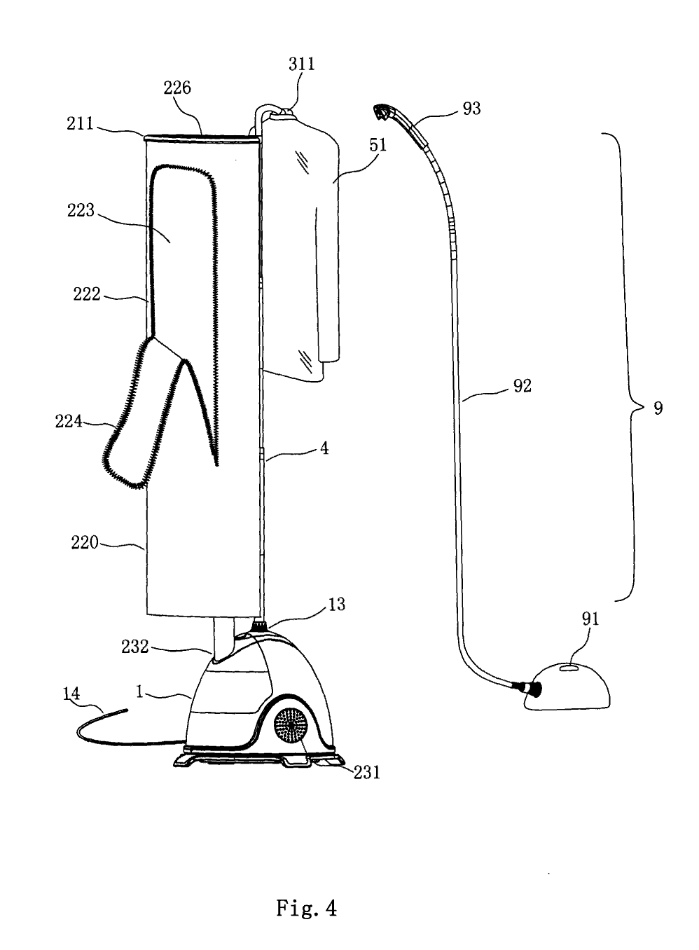

As shown in FIG. 4, the clothes to be dried are firstly hanged on the spare hanging member 31 of the spare unit 3, and a portable steam iron 9 having a handle 91, a hose 92 and a nozzle 93 is used to simply iron the clothes hanged on the spare hanging member 31. The humidity of the clothes is increased by absorbing the vapor after vapor-ironing the clothes with the portable steam iron 9, therefore, at this time, the ironed clothes cannot be immediately worn and stored by the user, and need being dried in the drying unit 2 at the other side of the pillar 4 until the humidity of the clothes is decreased to a degree at which the clothes can be directly worn and stored by the user.

As for the dryer-hanger single-body machine according to an embodiment of the present invention, the clothes may be firstly hanged in the spare unit 3 at one side of the pillar 4 and ironed by the portable steam iron 9, and then the ironed clothes may be transferred into and dried in the drying unit 2 at the other side of the pillar 4; subsequently, the clothes may be hanged in the spare unit 3 and ironed by the portable steam iron 9 again; finally, the clothes may be transferred into and dried in the drying unit 2 again to remove the vapor absorbed in the clothes. In this way, the process of the clothes may be finished. With the dryer-hanger single-body machine of the present invention, it can reduce the abrasion to the clothes, and the ironing and drying operation of expensive clothes may be simply carried out in families. Furthermore, it provides a simple and effective operation environment for ironing the clothes with the portable steam iron 9 and need occupying small room space.

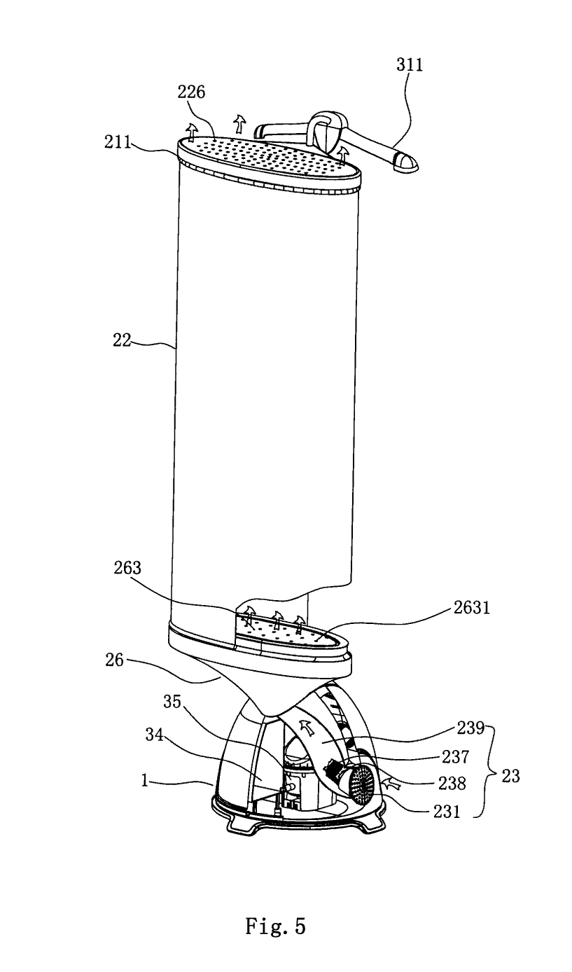

As shown in FIG. 5, a chamber 26 may be provided at the bottom of the hood 22 to communicate the vent port 232 of the heating member 23 with the air inlet 225. The caliber of the upper end face of a top plate 263 of the chamber 26 is matched with that of the air inlet 225 of the hood 22. The air inlet 225 is fixed on the peripheral side of the top plate 263 of the chamber. A plurality of vent holes 2631 are formed in the top plate 263. The bottom of the chamber 26 is hermetically communicated with the vent port 232 to allow the hot air from the blower 238 and the heating element 237 to flow into the chamber 26 through the air passage 239. A slow air chamber 261 is formed in the chamber 26 to decrease the temperature of the hot air flow before the hot air flows into the receiving space 223 for drying clothes through the vent holes 2631 in the top plate 263. The chamber 26 also serves to spread out the lower portion 220 of the hood. The outer of the chamber 26 may be fixed on the pillar 4 at a side thereof or fixed on both the pillar 4 and the supporting body 1.

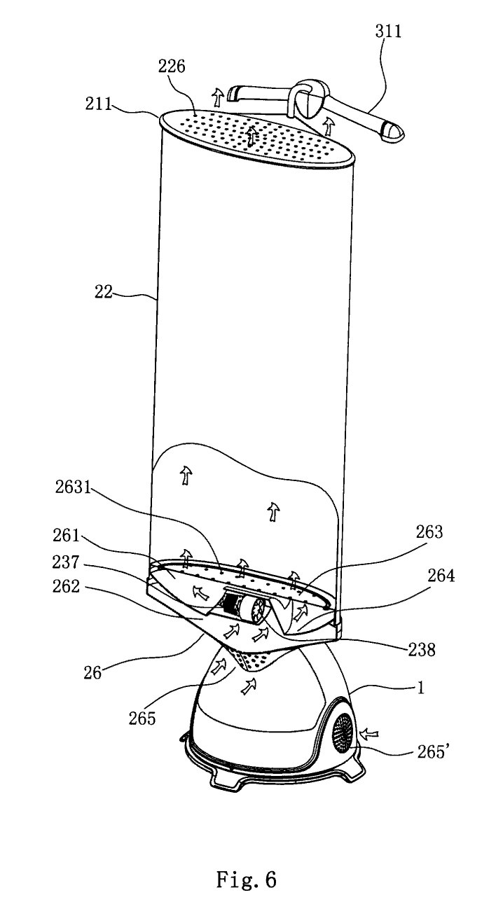

Furthermore, as shown in FIG. 6, a separate plate 264 is disposed within the chamber 26 to separate the chamber 26 into an upper slow air chamber 261 and a lower electronic chamber 262 communicated with the upper slow air chamber 261. The heating member 23 comprising a blower 238 and a heating element 237 is fixed on the separate plate 264 in the lower electronic chamber 262. An intake holes 265 for supplying external air into the lower electronic chamber 262 is formed in the case of the lower electronic chamber 262 of the chamber 26. Alternatively, an intake hole 265′ may be formed in the case of the supporting body 1. A passage is formed in the supporting body 1 to communicate the intake hole 265′ and the lower electronic chamber 262.

Second Embodiment

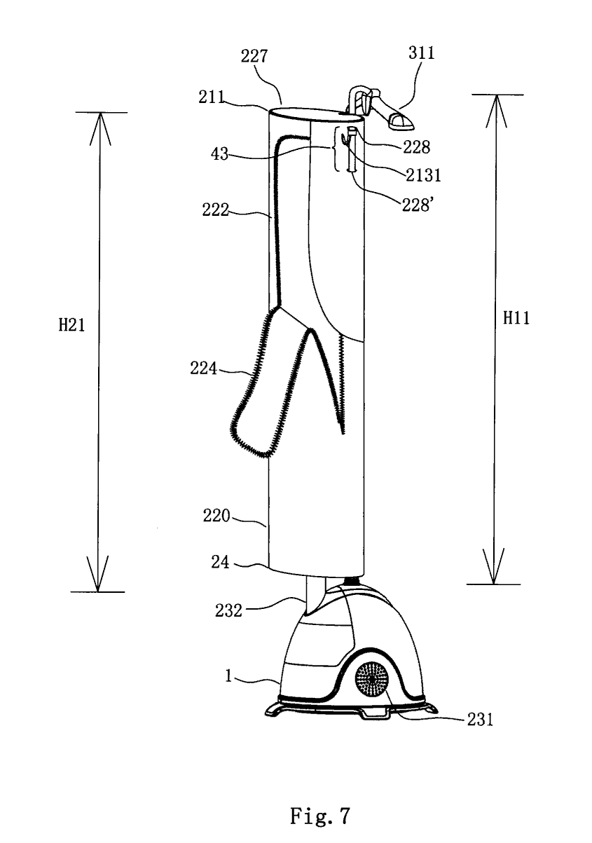

Hereafter it will only describe the difference of the second embodiment shown in FIGS. 7-8 from the first embodiment.

As shown in FIGS. 7-8, a lower aperture 228′ and an upper aperture 228 are formed in a back side 221 of the hood 22. A section 43 of the pillar 4 enters into a receiving space 223 inside the hood 22 through the lower aperture 228′ and the upper aperture 228 and is kept in the receiving space 223 to fix the back side 221 of the hood to prevent the hood 22 from swaying. Furthermore, a clothes-hook 2131 may be provided on the section 43 of the pillar 4 positioned in the receiving space 223 to hang the clothes being dried in the drying unit 2. Preferably, a plurality of clothes-hooks 2131 may be provided on the section 43 in a down-up direction to hang and dry the clothes in the down-up direction.

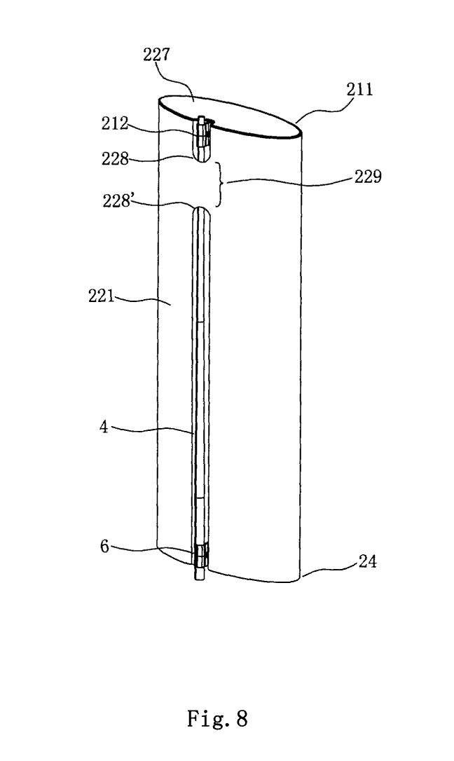

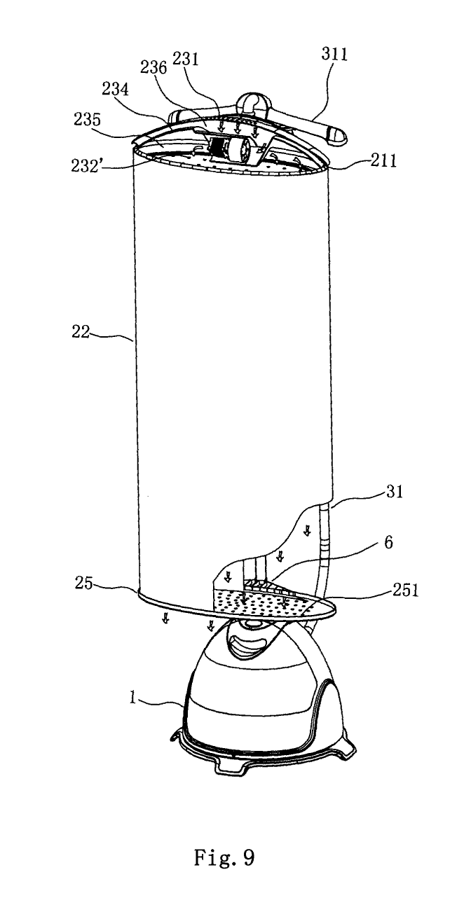

A bottom frame 24 is provided at the bottom of the hood 22 to prevent the lower portion 220 of the hood from swaying. A side fastener 6 is fixed on a side of the bottom frame 24 adjacent to the pillar 4, and the bottom frame 24 is secured to the pillar 4 by the fastener 6. In this way, the lower portion 220 of the pillar 4 is stably fixed on the pillar 4. Alternatively, the bottom frame 24 may be replaced by a bottom plate 25 shown in FIG. 9, the air inlet 225 of the hood 22 is formed in the bottom frame 24 or the bottom plate 25.

Third Embodiment

Hereafter it will only describe the difference of the third embodiment shown in FIGS. 9-11 from the first embodiment.

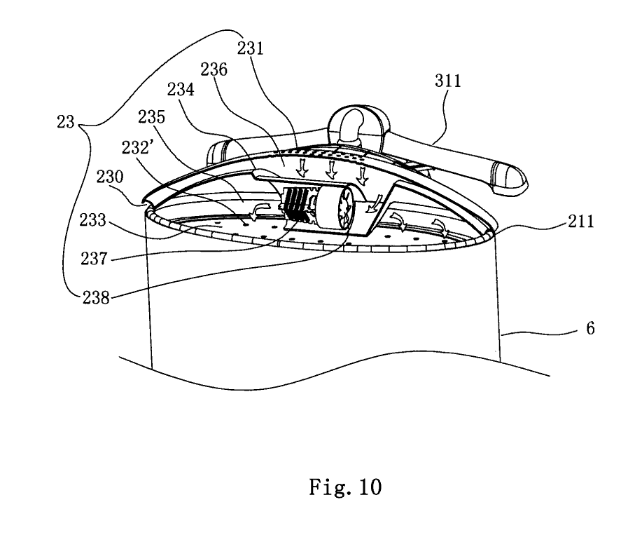

As shown in FIGS. 9-11, the heating member 23 is fixed on a location of the upper end 41 of the pillar at a side of the drying unit 2. The upper end of the hood 22 is sleeved on the outer circumference of the supporting top frame 211, and the supporting top frame 211 is fixedly received in a ring recess 230 provided in a lower portion outside of the case of the heating member 23. The hood 22 extends and spreads downward along the supporting top frame 211. A bottom plate 25 is provided at a bottom of the hood to spread a lower portion 220 of the hood. The bottom plate 25 is secured to the lower end of the pillar 4 by a side fastener 6. An air hole 251, that is, an air outlet for allowing the air to flow therethrough, is formed in the bottom plate 25. An intake port 231 is formed in a top case of the heating member 23. A separate plate 234 is disposed within the heating member 23 to separate the case of the heating member 23 into an upper electronic chamber 236 and a lower slow air chamber 235 communicated with the upper electronic chamber 236. A blower 238 and a heating element 237 of the heating member 23 are coaxially fixed on the separate plate 234 within the electronic chamber 236. The external air flows into the upper electronic chamber 236 in a direction indicated by arrows shown in FIGS. 9-10 through the intake port 231 in the top case of the heating member 23. The air is drawn in by the blower 238 and heated by the heating element 237, then the heated air enters into the slow air chamber 235 and flows into the receiving space 223 for drying the clothes in the hood through a plurality of vent holes 232′ distributed in a bottom plate 233 of the case of the heating member 23, at this time, the upper port of the hood 22 is acted as the air inlet. In this way, the configuration to dry clothes is accomplished.

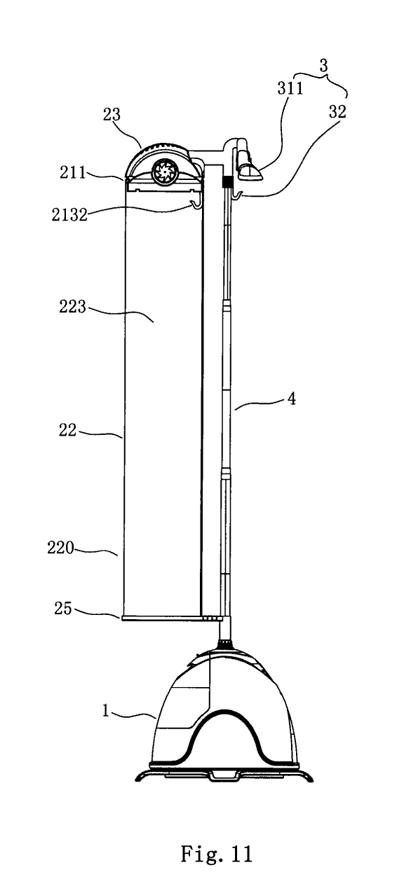

Furthermore, a temperature control device may be provided in the slow air chamber 235 so that the temperature of the air flowing into the receiving space 223 corresponds to different material clothes. The case of the heating member 23 and the pillar 4 may be made as one piece, as shown in FIG. 11. A clothes-hook 2132 may be provided on the bottom plate 233 of the case of the heating member 23, the clothes-hook 2132 extends toward the receiving space 223 for hanging the dried clothes. Also, a further clothes-hook 32 may be provided under the hanger 311 of the spare member 31 or on the pillar 4 for directly hanging a hanger with clothes on the clothes-hook 32, instead of taking the clothes off the hanger and then place it on the hanger 311.

Fourth Embodiment

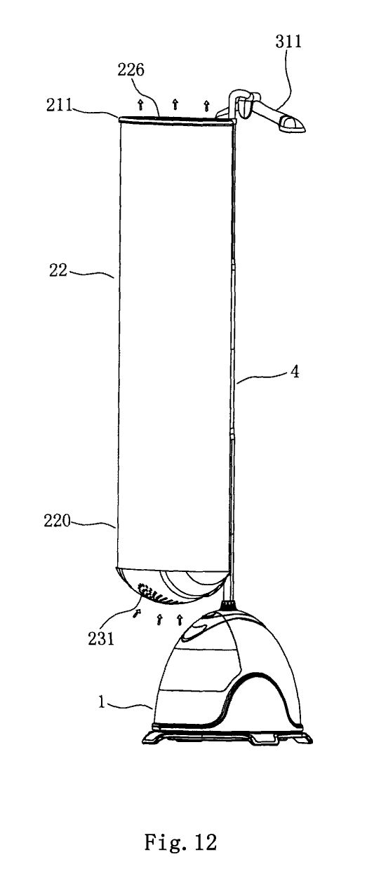

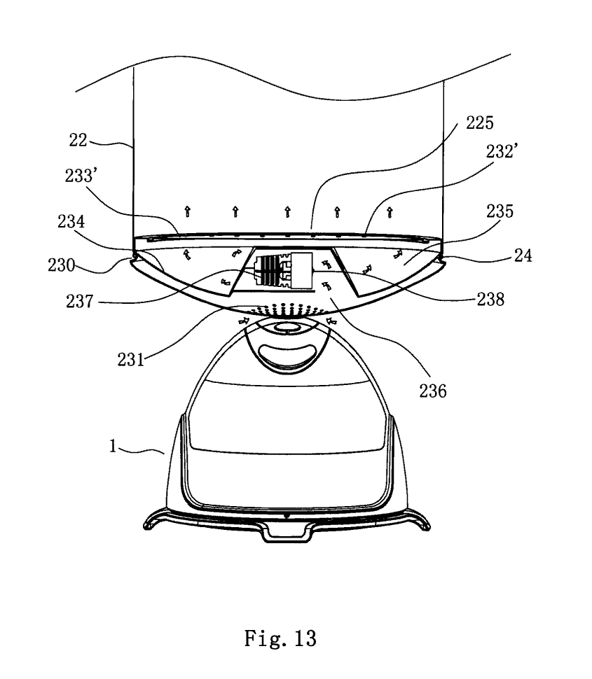

Hereafter it will only describe the difference of the fourth embodiment shown in FIGS. 12-13 from the third embodiment.

As shown in FIGS. 12-13, the heating member 23 may be fixed on a portion of the pillar 4 between the drying rack member 21 and the supporting body 1, that is, may be fixed on the lower end of the pillar 4 to configure a lower-heating and drying structure. Alternatively, the hot air may be applied at any location in the receiving space 223 inside the hood 22. As shown in FIGS. 12-13, the heating member 23 is fixed on the lower end of the pillar 4 between the drying rack member 21 and the supporting body 1. An intake port 231 is formed in the bottom case of the heating member 23. A separate plate 234 is disposed within the heating member 23 to separate the case of the heating member 23 into an upper slow air chamber 235 and a lower electronic chamber 236 communicated with the upper slow air chamber 235. A blower 238 and a heating element 237 of the heating member 23 are coaxially fixed in a recess part of the separate plate 234 within the electronic chamber 236.

The caliber of an upper end surface of a case top plate 233′ of the electronic chamber 236 is matched with that of the air inlet 225 in the bottom of the hood 22. A bottom frame 24 is sleeved on the bottom air inlet 225 of the hood 22, and the bottom frame 24 is fixed in a ring recess 230 formed at an outer side wall of the case of the heating member 23. In this way, the bottom air inlet 225 of the hood 22 is communicated with a plurality of vent holes 232′ in a case top plate 233′ of the heating member 23 to allow the external air to flow in a direction indicated by arrows shown in FIGS. 12-13. The external air flows into the electronic chamber 236 through the intake port 231 in the lower portion of the heating member 23 and is drawn in by the blower 238 and heated by the heating element 237, then the heated air enters into the slow air chamber 235 and flows into the receiving space 223 for drying the clothes in the hood through a plurality of vent holes 232′ distributed in the case top plate 233′ of the case of the heating member 23. In this way, the configuration to dry clothes is accomplished. The drying rack member 21 on the top of the hood 22 comprises a supporting top frame 211 and a side fastener 212 to fix the supporting top frame 211 on the upper end of the pillar 4.

Fifth Embodiment

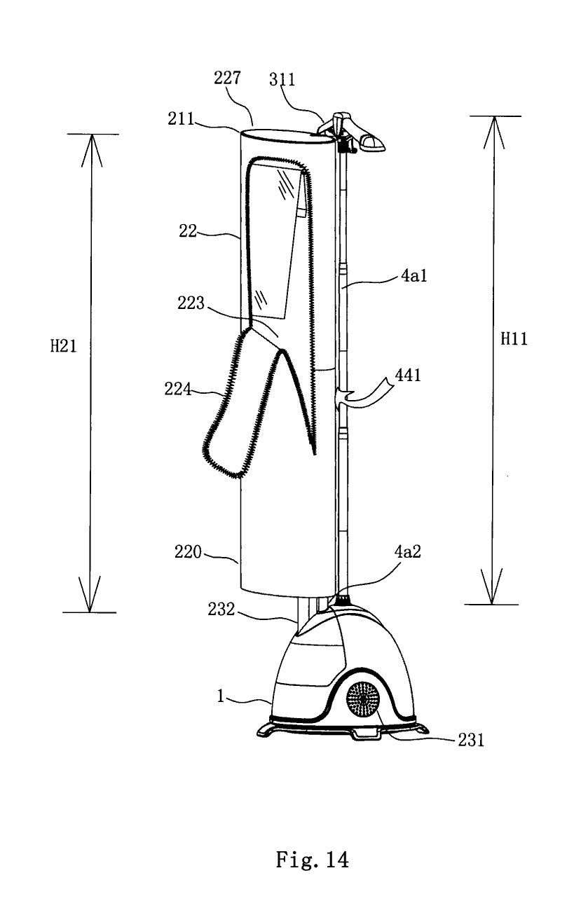

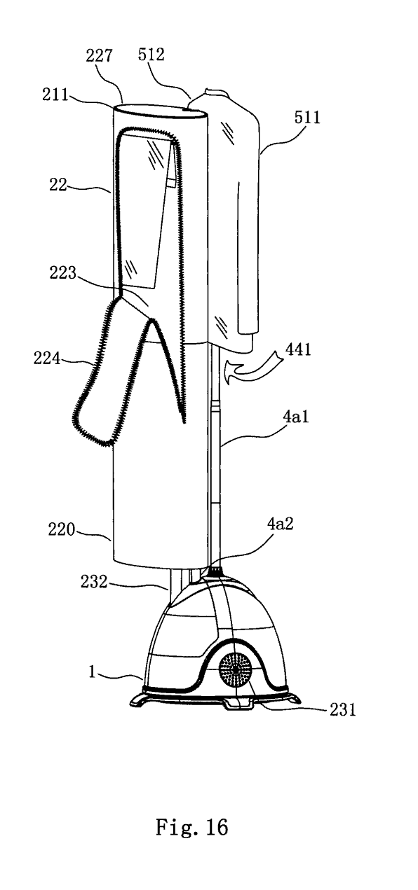

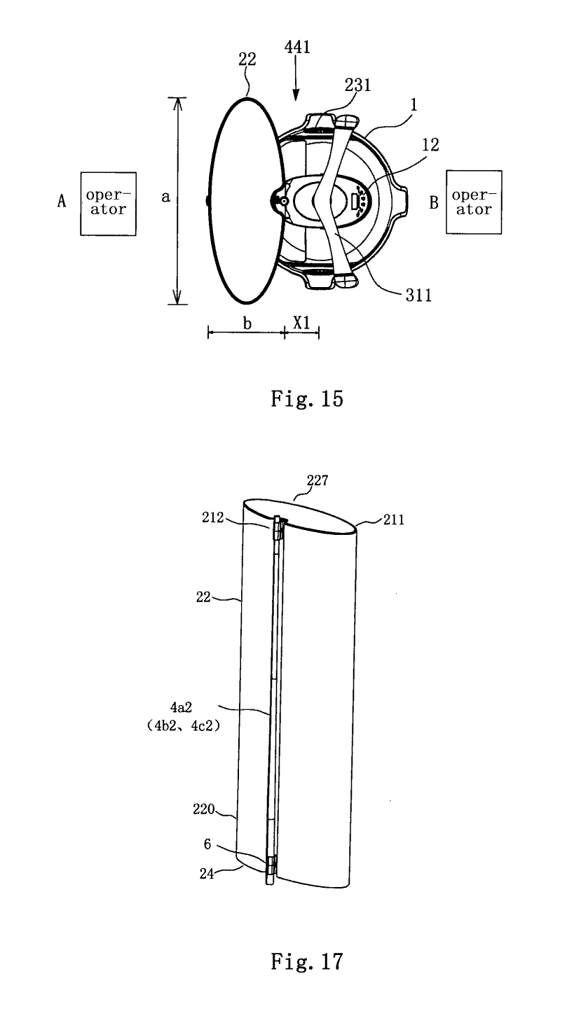

Hereafter it will only describe the difference of the fifth embodiment shown in FIGS. 14-17 from the above four embodiments.

As shown in FIGS. 14-17, the pillar 4 consists of a first supporting rod 4a1 having a first predetermined height H11 and a second supporting rod 4a2 having a second predetermined height H21 that are separated from each other by a predetermined horizontal distance X1 and fixed on a portion of the supporting body 1 at a side where the vent port 232 is provided. That is, the first and second supporting rods are configured to be parallel to each other to form a “∥”-shaped structure. Preferably, the horizontal distance X1 between the first and second supporting rods is in a range of 10 cm to 25 cm so that the spare clothes 51 can freely pass through a passage 441 formed between the first and second supporting rods and be hanged on the spare hanging member 31. The drying rack member 21 comprises a supporting top frame 211 on the upper end of the hood 22. The supporting top frame 211 has an elliptic shape and is formed with an upper port 227 (that is, the vent port). The supporting top frame 211 has a receiving width ‘a’ equal to a width between two shoulders of a jacket, as well as a receiving thickness ‘b’ equal to a thickness between chest and back of the jacket. A side fastener 212 is fixed on the outer periphery of the supporting top frame 211 and located at a middle location of the supporting top frame in a direction of the receiving width. The top of the hood 22 is suspended on the supporting top frame 211 and secured to the second supporting rod 4a2 by the side fastener 212 so that the hood 22 is fixed on an outside of the second supporting rod 4a2 opposite to the passage 441. The hood 22 axially extends along the left side of the second supporting rod 4a2 and spreads to form a receiving space 223, and the upper port 227 of the hood faces upward to enlarge the receiving space 223 in the hood 22. A door 224 for the placement-retrieval or accessing of clothes is opened in the front outside 22 of the hood. An air inlet is formed in the lower portion of the hood 22 and hermetically connected to the vent port 232 to introduce the hot air flow generated by the heating member 23 into the receiving space 223 in the hood 22 to dry the clothes. The vapor from the dried clothes is discharged outside through the upper port 227 in the upper portion of the hood 22. Furthermore, the hood 22 has a bottom frame 24 at the bottom thereof. A side fastener 6 is provided on the side of the bottom frame 24 to fix the bottom frame 24 on the second supporting rod 4a2.

A hanger 311 is provided at the top end of the first supporting rod 4a1. The spare clothes 511, for example, a jacket, may pass through the passage 441 formed by the distance X1 between the first supporting rod 4a1 and the second supporting rod 4a2 and be hanged on the hanger 311. The user carries out the placement-retrieval of dried clothes and the whole drying operation in the drying region A at the left side of the second supporting rod 4a2, and carries out the placement-retrieval of spare clothes 511 in the spare region B at the right side of the first supporting rod 4a1. Accordingly, the hood 22 located at the left side of the second supporting rod 4a2 does not hinder the placement-retrieval of spare clothes 511.

Therefore, the drying process of clothes and the placement-retrieval process of spare clothes are not interfered with each other.

Sixth Embodiment

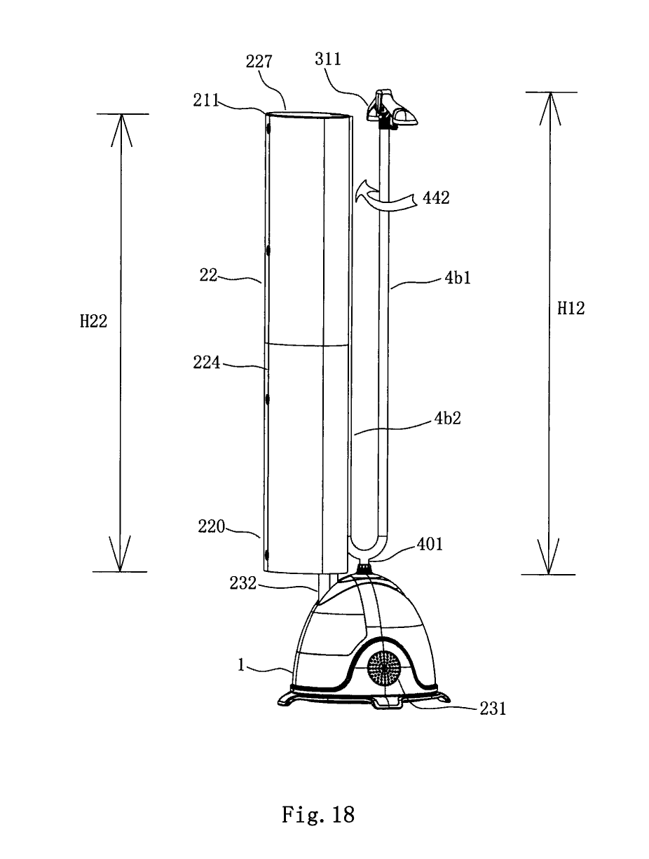

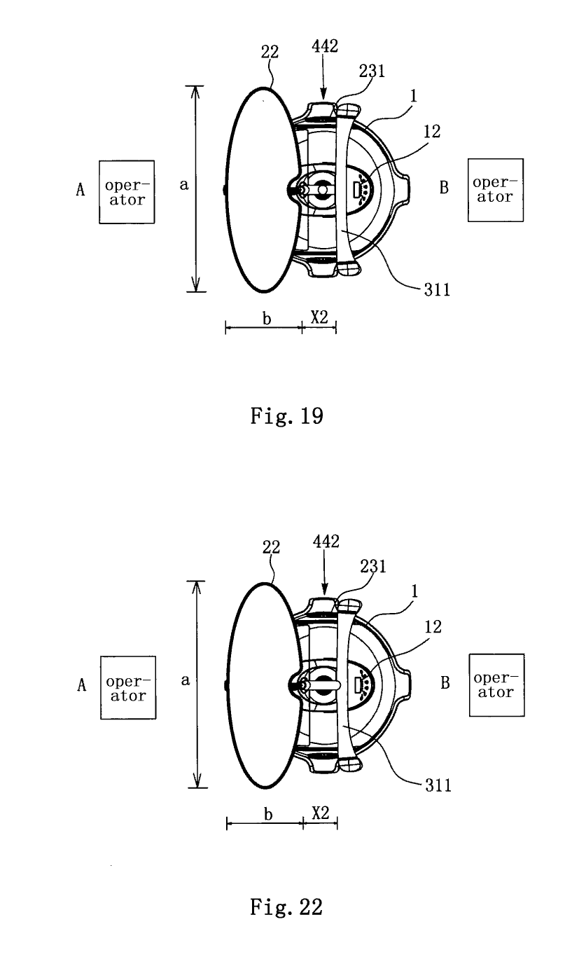

Hereafter it will only describe the difference of the sixth embodiment shown in FIGS. 18-20 from the fifth embodiment.

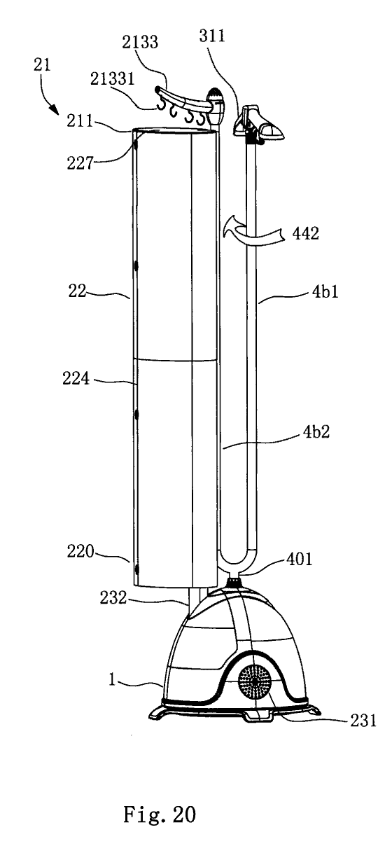

As shown in FIGS. 18-20, the pillar 4 consists of a first supporting rod 4b1 and a second supporting rod 4b2 of which upper ends are separated from each other by a predetermined horizontal distance X2 and of which lower ends are connected to each other to form a “Y”-shaped structure. The first supporting rod 4b1 has a first predetermined height H12, and the second supporting rod 4b2 has a second predetermined height H22. A passage 442 is formed between the first and second supporting rods 4b1, 4b2. Also, as shown in FIG. 20, the drying rack member 21 is fixed on the second supporting rod 4b2, and the spare hanging member 31 is fixed on the first supporting rod 4b1.

Seventh Embodiment

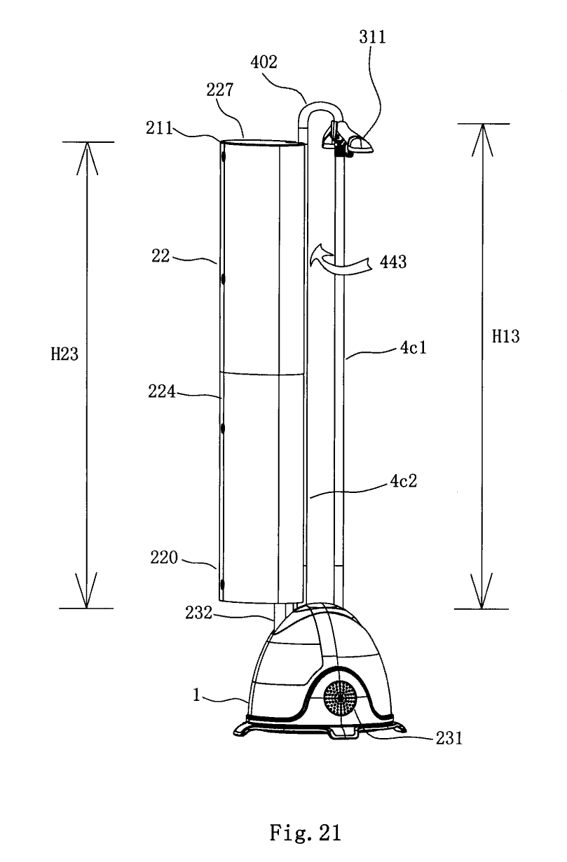

Hereafter it will only describe the difference of the seventh embodiment shown in FIGS. 21-22 from the fifth and the sixth embodiments.

As shown in FIGS. 21-22, the pillar 4 consists of a first supporting rod 4c1 and a second supporting rod 4c2 of which lower ends are separated from each other by a predetermined horizontal distance X3 and of which upper ends are connected to each other by a transition rod 402 to form an “n”-shaped structure. The first supporting rod 4c1 has a first predetermined height H13, and the second supporting rod 4c2 has a second predetermined height H23. A passage 443 is formed between the first and second supporting rods 4c1, 4c2.

Such configured pillar 4 is very stable because the upper ends of the first supporting rod 4c1 and the second supporting rod 4c2 is connected by the transition rod 402 and the swaying of the first and second supporting rods is decreased.

Eighth Embodiment

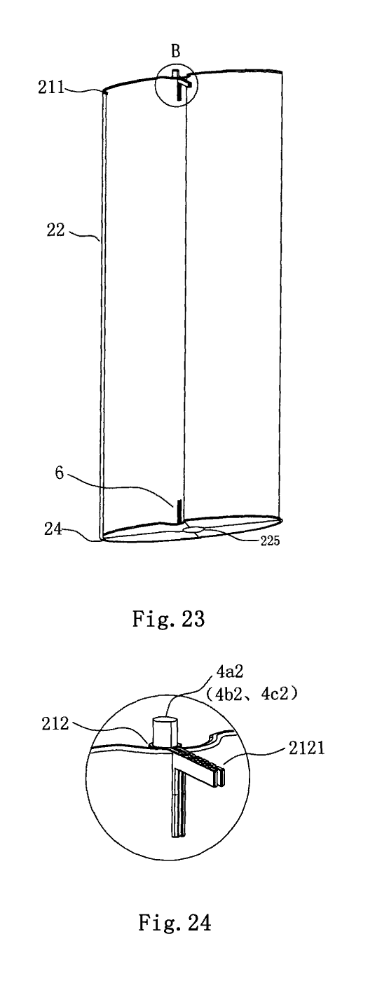

Hereafter it will only describe the eighth embodiment shown in FIGS. 23-24. FIG. 24 is a local enlarged view of a portion B indicated in FIG. 23. As shown in

FIGS. 23-24, the drying rack member 21 of the drying unit 2 also comprises a clothes-hanging means for hanging the dried clothes in the hood 22. The clothes-hanging means is configured to be a protruded arm 2121 extending toward the receiving space 223 from a side fastener 212. Positioning notches are formed in the protruded arm 2121 to separate the dried clothes from each other by intervals and allow the hot air to smoothly flow therebetween. Consequently, the hot air can penetrate the dried clothes for a decreased time, improving the efficiency of drying clothes. Alternatively, the clothes-hanging means may be a hook extending toward the receiving space 223 from the side fastener 212.

Ninth Embodiment

Hereafter it will only describe the difference of the ninth embodiment shown in FIGS. 20, 25-26 from the preceding embodiments.

In the preceding embodiments, the receiving space 223 formed between the supporting top frame 211 and the bottom frame 24 cannot be changed in shape, the supporting top frame 211 is fixed on the pillar 4 by the side fastener 212, and the bottom frame 24 is fixed on the lower end of the pillar 4 by the side fastener 6.

Conversely, in the ninth embodiment, the side fastener 6 is movable in a down-up direction along the pillar 4 so that the bottom frame 24 is also movable along the pillar together with the fastener 6. As a result, the height of the receiving space 223 in the hood 22 can be adjusted according to clothes with different lengths. Thereby, the hot air can dry the clothes in a suitable space to improve the utilization efficiency of the hot air and reduce the time for drying the clothes. Furthermore, it can avoid folding the clothes in a case where the height of the receiving space 223 is less than the length of the clothes to be dried.

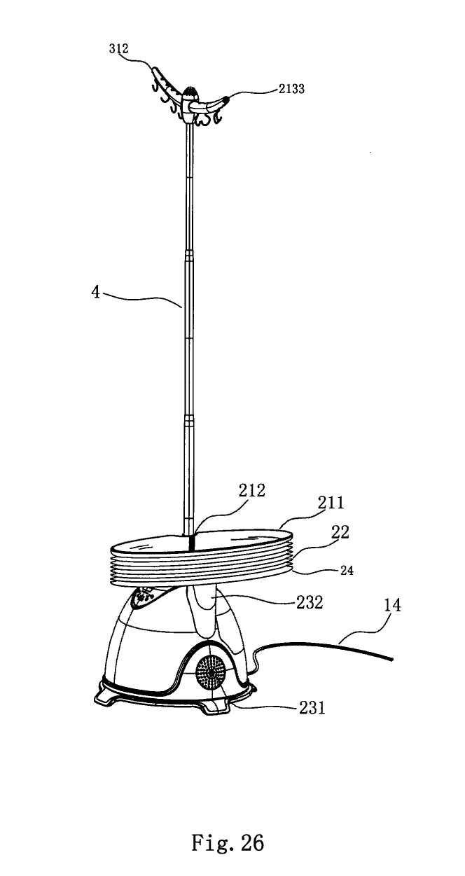

Alternatively, as shown in FIG. 26, the supporting top frame 211 also may be movable in the down-up direction along the pillar 4 together with the side fastener 212. When it is unnecessary to dry clothes, the supporting top frame 211 may be moved to the lower end 42 of the pillar and come close to the bottom frame 24 to fold the hood. At this time, the dryer-hanger single-body machine can be served as an apparatus for hanging spare clothes.

Also, as shown in FIGS. 9 and 11, the bottom frame 24 may be replaced by the bottom plate 25, and a plurality of vent holes 251 may be opened in the bottom plate 25.

As shown in FIG. 20, the drying unit 2 includes a clothes-hanging means that is configured to be a first extension arm 2133, on which a plurality of clothes-hooks 21331 are provided, extending from the top end of the pillar 4 toward a side of the drying rack member 21. The clothes to be dried are placed into the receiving space 223 through a door 224 in the front face of the hood. The top of the hanger for hanging the clothes passes through the upper port 227 in the top of the hood and is suspended on a clothes-hook 21331, and then the door 224 is closed to begin drying the clothes.

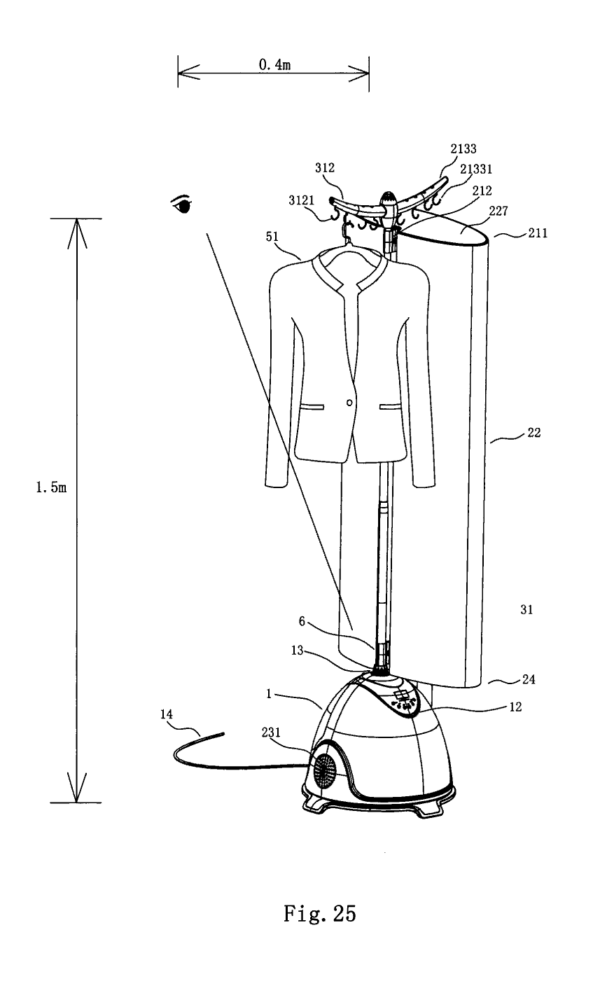

As shown in FIGS. 25-26, the clothes-hanging means of the spare member 31 and the clothes-hanging means of the drying unit 2 are configured to be one piece of extension arms on the upper end 41 of the pillar. A plurality of clothes-hooks 21331 are provided on a first extension arm 2133 at the side of the drying unit 2, and a plurality of clothes-hooks 3121 are provided on a second extension arm 312 at the side of the spare unit 3.

As shown in FIG. 25, a control panel 12 is provided on a region of the supporting body 1 outside a zone covered by the vertical projection of the hood 22. Accordingly, the control panel 12 is not hidden by the hood 22, and the user can easily watch the control panel 12 to know the state of drying clothes without needing to squat down at a place away from the supporting body 1 by 0.4 m to avoid the hood. That is, the user can directly watch the control panel 12 when he/she stands in a spare region B or a transition region C.

Tenth Embodiment

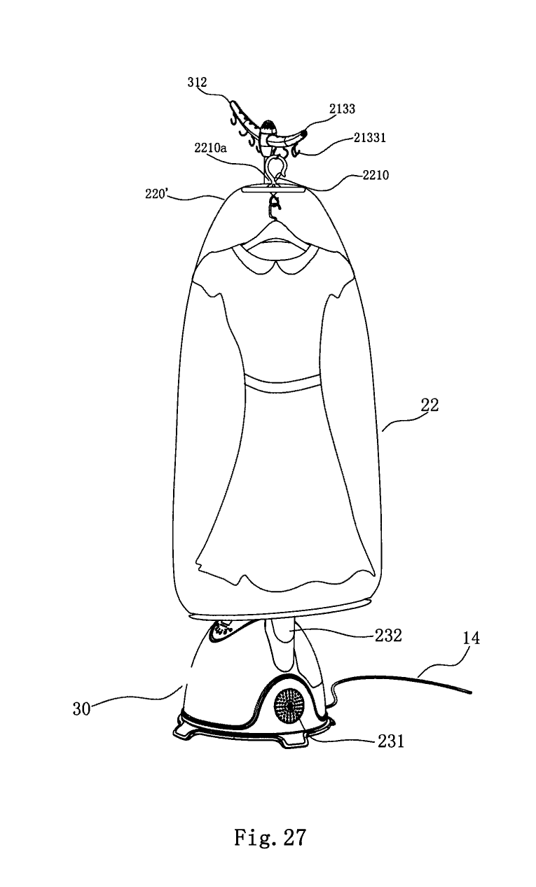

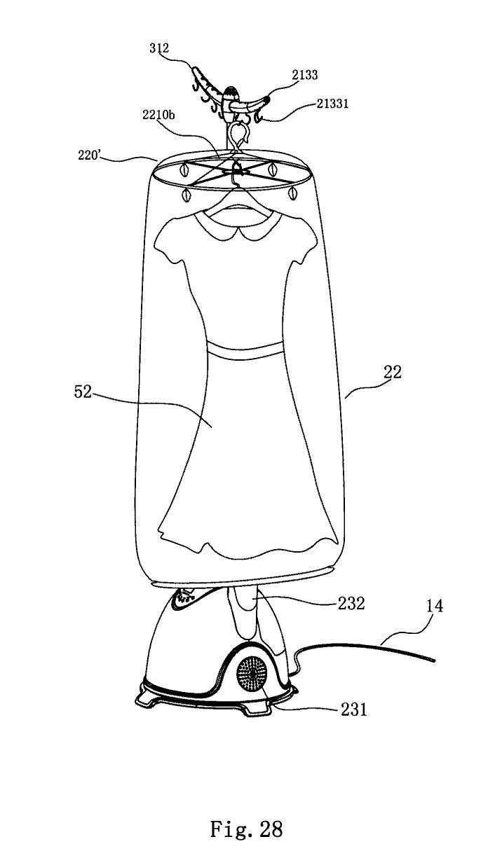

Hereafter it will only describe the difference of the tenth embodiment shown in FIGS. 27-28 from the ninth embodiment.

As shown in FIGS. 27-28, a spread means 2210 for spreading the hood 22 is provided on a top portion 220′ of the hood. The hood 22 is suspended on a clothes-hook 21331, which is provided on a first extension arm 2133 at one side of the upper end of the pillar 4, by the spread means 2210 to fix the hood 22 at the one side of the pillar 4. The hood 22 naturally drops downward along the spread means 2210 and is spread out by the spread means 2210. The spread means 2210 comprises a clothes-hanging structure 2210a for hanging the hood 22 and a pan-like structure 2210b for spreading the hood 22. The hood 22 is a movable hood and can be taken down and stored when it is not in use, thereby not occupying any room space. In addition, the hood 22 can be simply hanged up in use.

Eleventh Embodiment

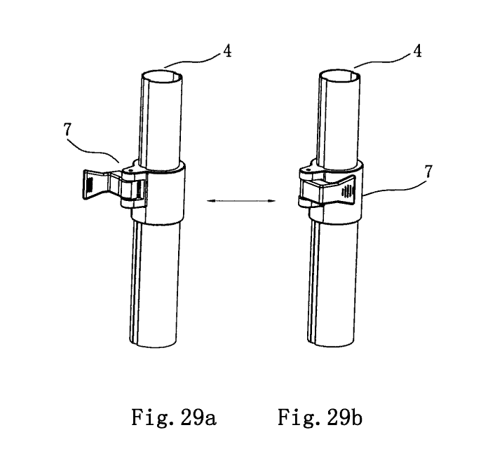

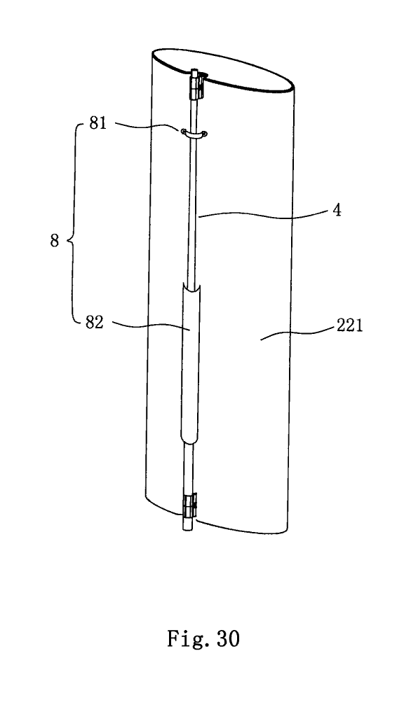

Hereafter it will only describe the difference of the eleventh embodiment shown in FIGS. 29a, 29b and 30 from the preceding embodiments.

FIG. 29a shows the pillar 4 in a loosened state, and FIG. 29b shows the pillar 4 in a locked state.

As shown in FIGS. 29a and 29b, the pillar 4 is configured to be a telescopic structure consisting of a plurality of segments that are gradually become finer from lower portion to upper portion one by one. A locking means 7 is provided at a joint of two adjacent segments to loosen or lock the pillar 4. In this embodiment, the locking means 7 comprises a spanner having a cam structure at an end thereof. The end of the spanner is hinged to a sheath sleeved on the pillar. The pillar can be locked when the end of the spanner abuts against the side wall of the pillar by turning the spanner or can be loosened when the end of the spanner leaves away from the side wall of the pillar by turning the spanner. In this way, the extension, insertion and fixation of the pillar 4 can be carried out, and the height of the pillar 4 can be adjusted according to various requirements from different persons. Furthermore, the pillar 4 may be configured to be a detachable structure consisting of a plurality of segments that are detachably connected to each other. When the dryer-hanger single-body machine is not in use, it can be detached by the following steps: removing the pillar 4 from the supporting body 1; drawing the side fastener 212 and the side fastener 6 out of the pillar 4; moving the supporting top frame 211 close to the bottom frame 24 or the bottom plate 25 to fold and frap the hood; withdrawing the segments of the pillar 4 to have a minimal volume for facilitating the storage and carriage of it.

Furthermore, as shown in FIG. 30, a fixing means 8 is further provided between the back side 221 of the hood and the pillar 4 to prevent the hood 22 from swaying relative to the pillar 4. The fixing means 8 comprises a fastener structure 81 striding over the pillar 4 and fixed on the back side of the hood 22, and a sleeve structure 82 for the pillar 4 passing therethrough.

Twelfth Embodiment

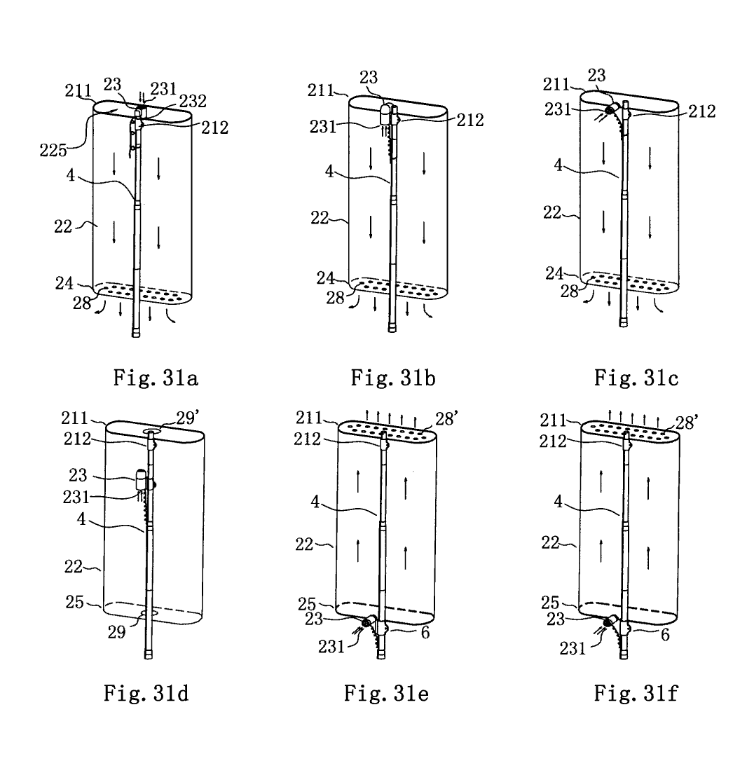

Hereafter it will describe the twelfth embodiment shown in FIGS. 31a to 31f.

As shown in FIGS. 31a to 31 f, the heating member 23 may be located at any position on the pillar 4.

Referring to FIG. 31a, the heating member 23 is located at the top end of the pillar 4 above the drying rack member 21. The vent port 232 of the heating member 23 faces down toward the hood 22. The intake port 231 of the heating member 23 is located at the top end of the heating member 23. The top of the hood 2 is acted as the air inlet 225. A plurality of vent holes 28 are formed in the bottom of the hood 22 to be acted as the air outlet. Furthermore, a bottom plate or a bottom frame 24 is also provided at the bottom of the hood.

Referring to FIG. 31b, the heating member 23 is also located at the top end of the pillar 4. However, the air inlet 225 may be not formed by the opened top of the hood 22. The vent port of the heating member 23 is communicated with the air inlet of the hood 22. A plurality of vent holes 28 also are formed in the bottom of the hood 22. Furthermore, a bottom plate or a bottom frame 24 is also provided at the bottom of the hood.

Referring to FIG. 31c, the heating member 23 is located on the supporting top frame 211 at the top of the pillar 4, and the vent port of the heating member 23 is communicated with the hood 22, for example, as shown in FIG. 31b, the vent port is communicated with the air inlet in the hood 22. Alternatively, as shown in FIG. 31a, the vent port may be directly faced toward the opened air inlet 225 in the top of the hood 22.

Referring to FIG. 31d, the heating member 23 is fixed on a middle location of the pillar 4 between the drying rack member 21 and the supporting body 1. The heating member 23 has an intake port 231. The vent port of the heating member 23 is communicated with the air inlet in the hood 22 for supplying the hot air into the hood 22. A larger vent hole 29 formed in the bottom plate 25 of the hood 22 and/or a larger vent hole 29′ formed in the top of the hood 22 are/is served as the air outlet of the hood 22.

Referring to FIG. 31e, the heating member is fixed at the bottom of the pillar 4. The air inlet 225 is not formed by the opened top of the hood 22 and is located at the other portion of the hood as shown in FIG. 31b. The heating member 23 has an air inlet 231. The vent port of the heating member 23 is communicated with the air inlet in the hood 22. The hood also has a bottom plate 25 or a bottom frame at the bottom thereof. The bottom plate or the bottom frame is fixed on the pillar 4 by the side fastener 6. A plurality of vent holes 28′ are formed in the top of the hood 22.

Referring to FIG. 31f, the heating member 23 is located at the bottom of the pillar 4. The heating member 23 is fixed on the bottom frame or the bottom plate 25 of the hood 22, which is different from FIG. 31e. The vent port of the heating member 23 is communicated with the air inlet in the hood 22. The bottom plate or the bottom frame is fixed on the pillar 4 by the side fastener 6. A plurality of vent holes 28′ are formed in the top of the hood 22.

Accordingly, the heating member 23 may be located at any position of the pillar 4 between the drying rack member 21 and the supporting body 1, that is, may be located at the portion of the pillar above the drying rack member 21, at the middle portion of the pillar between the drying rack member 21 and the supporting body 1, at the bottom of the pillar 4, or even at the drying rack member 21 or the bottom frame 24 or the bottom plate 25 at the bottom of the hood 22 to provide various structures for the user to select.

Thirteenth Embodiment

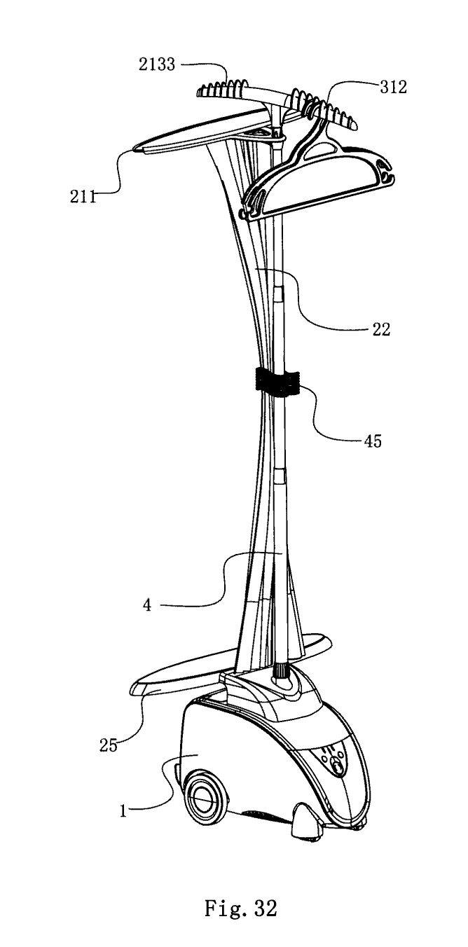

The thirteenth embodiment shown in FIG. 32 is substantially same as the fifth embodiment. Hereafter it will only describe the difference of the thirteenth embodiment from the fifth embodiment.

As shown in FIG. 32, the dryer-hanger single-body machine further comprises a tying means 45 for tying the hood 22 on the pillar 4. In this embodiment, the tying means 45 is located at a middle portion of the pillar 4 and comprises a clamp fixed on the pillar. Furthermore, in this embodiment, the hood 22 may be closed at a side near the pillar 4 along the supporting top frame 211 and the bottom plate 25. The tying means 45 may be used to tie the closed hood 22 on the pillar 4, thereby decreasing the volume of the dryer-hanger single-body machine when it is not in use.

Also, the tying means 45 may comprise a viscous fastener. Alternatively, the tying means 45 may comprise a tape having an end positioned on the hood and snappers provided on both ends of the tape. When one end of the tape is rounded over the pillar and mated with the other end by the snappers, the hood is tied on the pillar. But the present invention is not limited to this, other common tying means, for example, a tape independent of the pillar or the hood, may be used to tie the hood 22 on the pillar.

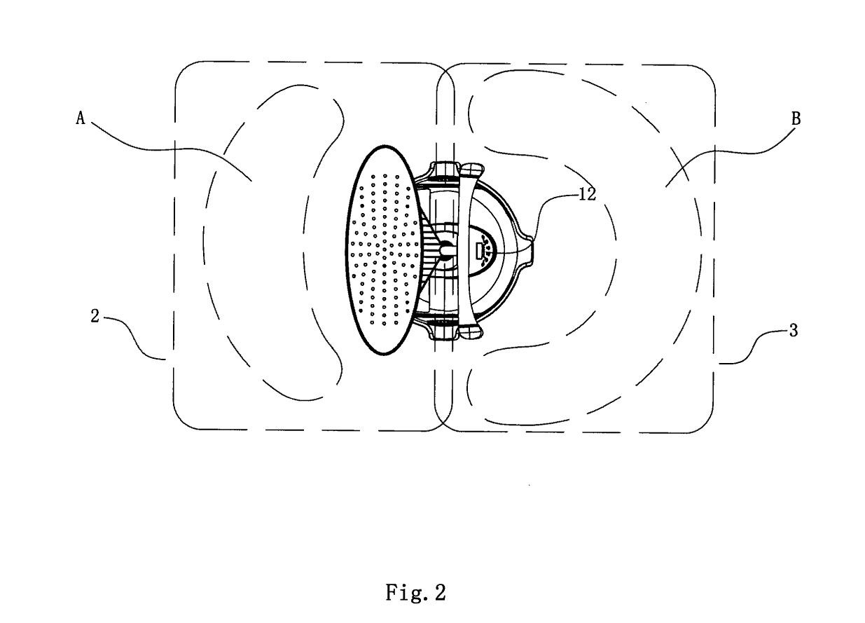

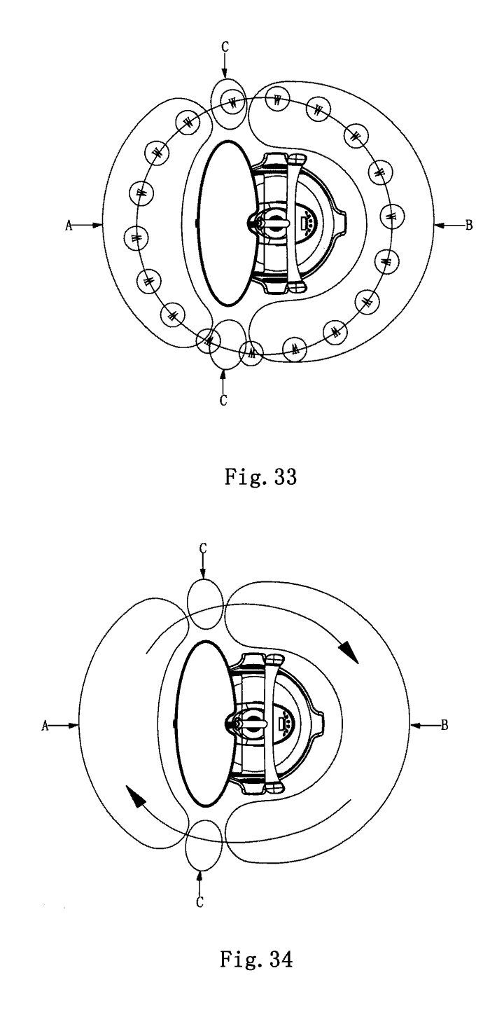

When the dryer-hanger single-body machine according to the above embodiments is in use, as shown FIGS. 2, 33-34, two operators may simultaneity and individually carry out the drying operation of the clothes and the steam ironing operation of the clothes, and one of operators may carry out the drying operation and the steam ironing operation on the clothes in the drying region A and the spare region B until they complete respective works. Alternatively, two operators may carry out the drying operation and the steam ironing operation in the drying region A and the spare region B, respectively, and the two operators may exchange their regions to carry out respective operation through a transition region C, and the exchange process may be repeated. Alternatively, two operators may carry out the drying operation and the steam ironing operation in the drying region A and the spare region B, respectively, and then the two operators may both carry out the drying operation of the clothes in the drying region A.

In the dryer-hanger single-body machine according to the present invention, the spare member and the detachable hood are provided at both sides of the pillar, respectively. In this way, the drying operation of the clothes may be carried out at one side of the pillar without needing to take down the clothes hanged on the spare member at the other side of the pillar.

That is, the drying operation of wet clothes and the placement-retrieval operation of spare clothes can be carried out at the same time and are not interfered with each other. As a result, the present invention can overcome the disadvantages occurred in the conventional dryer-hanger single-body machine in which the heat is wasted and various operations of the clothes are interfered with each other because all operations of the clothes are carried out in a same structure. Furthermore, the present invention improves the convenience of the operations of the clothes, decreases the difficulty in the operation process, saving the power consumption, and needs occupying a small space and is specially adapted to be used in a small room of the family.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A dryer-hanger single-body machine, comprising:
a supporting body (1) located at a base of the dryer-hanger single-body machine;
a pillar (4) vertically provided above the supporting body (1);
a drying unit (2) located at one side of the pillar (4); and
a spare unit (3) located at the other side of the pillar (4),
wherein the drying unit (2) comprising:
a drying rack member (21) located at one side of an upper end of the pillar (4);
a hood (22) supported on the drying rack member (21) and naturally hanging down along one side of the pillar (4); and
a heating member (23) for supplying a heated air into an inside space of the hood (22),
wherein the hood (22) is provided with an air outlet (226) and an air inlet (225),
a vent port (232) of the heating member (23) is offset from the pillar (4) and hermetically connected to the air inlet (225) of the hood (22), and
the spare unit (3) comprises a spare hanging member (31) having a clothes-hanger (311).

2. The dryer-hanger single-body machine according to claim 1,
wherein the heating member (23) is disposed within the supporting body (1);
an intake port (231) and the vent port (232) are provided in a case of the supporting body (1);
an air passage (239) is formed within the supporting body (1) and located between the intake port (231) and the vent port (232); and
the heating member (23) comprises a blower (238) and a heating element (237) located within the air passage (239).

3. The dryer-hanger single-body machine according to claim 2,
wherein a chamber (26) is provided between the vent port (232) of the heating member (23) and the air inlet (225) formed in a bottom of the hood (22); and
a top plate (263) of the chamber (26) is matched with the air inlet (225) of the hood (22) and has a plurality of vent holes (2631) communicated with the hood (22).

4. The dryer-hanger single-body machine according to claim 1,
wherein a chamber (26) is provided between the hood (22) and the supporting body (1) and connected to the air inlet (225) of the hood (22);
the chamber (26) is communicated with an intake hole (265, 265′);
a separate plate (264) is disposed within the chamber (26) to separate the chamber (26) into an upper slow air chamber (261) and a lower electronic chamber (262) communicated with the upper slow air chamber (261); and
the heating member (23) is fixed on the separate plate (264).

5. The dryer-hanger single-body machine according to claim 4,
wherein the intake hole (265) is formed in a side wall of the chamber (26); or
the chamber is communicated with the supporting body (1), and the intake hole (265′) is formed in supporting body (1).

6. The dryer-hanger single-body machine according to claim 1,
wherein the heating member (23) is fixed on a portion of the pillar (4) above the drying rack member (21), a middle portion of the pillar (4) between the drying rack member (21) and the supporting body (1), or a lower end of the pillar (4).

7. The dryer-hanger single-body machine according to claim 6,
wherein in a case where the heating member (23) is fixed on the portion of the pillar (4) above the drying rack member (21), a separate plate (234) is disposed within a case of the heating member (23) to separate the case of the heating member (23) into an upper electronic chamber (236) and a lower slow air chamber (235) communicated with the upper electronic chamber (236);
a blower (238) and a heating element (237) of the heating member (23) are coaxially fixed on the separate plate (234) within the electronic chamber (236); and
an intake port (231) is formed in an upper end of the case of the heating member (23), and a plurality of vent holes (232′) are distributed in a bottom plate (233) of the case of the heating member and communicated with an upper port of the hood (22) that is acted as the air inlet (225).

8. The dryer-hanger single-body machine according to claim 6,
wherein in a case where the heating member (23) is fixed on the lower end of the pillar (4), a plurality of vent holes (232′) are formed in a top plate (233′) of a case of the heating member (23) and communicated with a lower port of the hood (22) that is acted as the air inlet (225);
a plurality of intake ports (231) are formed in a bottom of the case of the heating member (23);
a separate plate is disposed within the case of the heating member (23) to separate the case into a lower electronic chamber (236) and an upper slow air chamber (235) communicated with the lower electronic chamber (236); and
a blower (238) and a heating element (237) of the heating member (23) are coaxially fixed on the separate plate (234) within the electronic chamber (236).

9. The dryer-hanger single-body machine according to claim 1,
wherein the drying rack member (21) comprises a supporting top frame (211) and a side fastener (212) located on the supporting top frame (211); and
a top end of the hood (22) is fixed on the supporting top frame (211) and secured on the upper end of the pillar (4) by the side fastener (212).

10. The dryer-hanger single-body machine according to claim 9,
wherein the supporting top frame (211) has an elliptic shape with a receiving width (a) equal to a width between two shoulders of a jacket, as well as a receiving thickness (b) equal to a thickness between chest and back of the jacket; and
the side fastener (212) is located at a middle location of the supporting top frame in a direction of the receiving width (a).

11. The dryer-hanger single-body machine according to claim 9,
wherein in a case where the heating member (23) is fixed on the portion of the pillar (4) above the drying rack member (21), the supporting top frame (211) is fixed in a ring recess (230) formed at an outside of the bottom of the case of the heating member (23).

12. The dryer-hanger single-body machine according to claim 1,
wherein the bottom of the hood (22) includes a bottom frame (24) or a bottom plate (25) that is secured on the lower end of the pillar (4) by a side fastener (6).

13. The dryer-hanger single-body machine according to claim 12,
wherein in a case where the heating member (23) is fixed on the lower end of the pillar (4), the bottom frame (24) is received in a ring recess (230) formed at an outside of the top of the case of the heating member (23).

14. The dryer-hanger single-body machine according to claim 1,
wherein the spare hanging member (31) further comprises a clothes-hook (32) located below the clothes-hanger (311) and fixed on the pillar.

15. The dryer-hanger single-body machine according to claim 1,
wherein a lower aperture (228′) and an upper aperture (228) are formed in a back side of the hood (22); and
a section (43) of the pillar (4) enters into an inside of the hood (22) through the lower aperture (228′) and the upper aperture (228).

16. The dryer-hanger single-body machine according to claim 1,
wherein the back side (221) of the hood (22) has a fixing means (8) to be fixed on the pillar (4).

17. The dryer-hanger single-body machine according to claim 16,
wherein the fixing means (8) is configured to be a fastener structure (81) striding over the pillar (4) and fixed on the back side of the hood (22), a sleeve structure for the pillar (4) passing therethrough, or a combination structure thereof.

18. The dryer-hanger single-body machine according to claim 1,
wherein the drying unit (2) includes a clothes-hanging means that is configured to be a first extension arm (2133), on which a plurality of clothes-hooks (21331) are provided, extending from the top end of the pillar (4) toward a side of the drying rack member (21); and
the spare unit (3) includes a further clothes-hanging means that is configured to be a second extension arm (312), on which a plurality of clothes-hooks (3121) are provided, extending from the top end of the pillar (4) toward a top of the spare unit (3).

19. The dryer-hanger single-body machine according to claim 1,
wherein the pillar (4) comprises a first supporting rod (4a1) and a second supporting rod (4a2) that are separated from each other by a predetermined horizontal distance and parallel to each other to form a “∥”-shaped structure; and
the drying rack member (21) is located on the second supporting rod (4a2), and the spare unit (3) is located on the first supporting rod (4a1).

20. The dryer-hanger single-body machine according to claim 1,
wherein the pillar (4) comprises a first supporting rod (4b1) and a second supporting rod (4b2) of which upper ends are separated from each other by a predetermined horizontal distance and of which lower ends are connected to each other to form a “Y”-shaped structure; and
the drying rack member (21) is located on the second supporting rod (4b2), and the spare unit (3) is located on the first supporting rod (4b1).

21. The dryer-hanger single-body machine according to claim 1,
wherein the pillar (4) comprises a first supporting rod (4c1) and a second supporting rod (4c2) of which lower ends are separated from each other by a predetermined horizontal distance and of which upper ends are connected to each other to form a “n”-shaped structure; and
the drying rack member (21) is located on the second supporting rod (4c2), and the spare unit (3) is located on the first supporting rod (4c1).

22. The dryer-hanger single-body machine according to claim 1,
wherein the drying rack member (21) comprises a spread means (2210) having a clothes-hanging structure (2210a) and a pan-like structure (2210b) for spreading the hood (22); and
the clothes-hanging structure (2210a) is hanged on a first extension arm (2133) laterally extending from the top end of the pillar (4).

23. The dryer-hanger single-body machine according to claim 1,
wherein the pillar (4) is configured to be a telescopic structure comprising a plurality of segments; and
a locking means is provided at a joint of two adjacent segments.

24. The dryer-hanger single-body machine according to claim 1, further comprises a tying means (45) for tying the hood (22) on the pillar (4).
